(19) United States
(12) Patent Application Publication
(10) Pub. No.: US 2005/0018092 A1
(43) Pub. Date: Jan. 27, 2005

(54) Projection television

(76) Inventors: Jae-hoo Park, Suwon-si (KR); Sang-hak Kim, Suwon-si (KR)

Correspondence Address: STANZIONE & KIM, LLP, 1740 N STREET, N.W., FIRST FLOOR, WASHINGTON, DC, 20036, US

(21) Appl. No.: 10/854,193

(22) Filed: May 27, 2004

(30) Foreign Application Priority Data
Jun. 2, 2003 (KR) 2003-35301

(51) Int. Cl. H04N 5/64

(52) U.S. Cl. 348/787; 348/789

(57) ABSTRACT

A projection television having a variable thickness. The projection television can include a front case on which a screen is installed, a rear case forming a main body with the front case, a projector installed in the main body, a reflecting mirror installed in the main body to reflect an image projected from the projector onto the screen, and a coupling device that can couple the front case and the rear case so that the front case can approach the rear case or separate from the rear case, and the entire thickness of the main body can be variable.

### CROSS-REFERENCE TO RELATED APPLICATIONS

This application claims the priority of Korean Patent Application No. 2003-35301, filed on Jun. 2, 2003, in the Korean Intellectual Property Office, the disclosure of which is incorporated herein in its entirety by reference.

### BACKGROUND OF THE INVENTION

1. Field of the Invention

The present invention relates to a projection television, and more particularly, to a projection television having variable thickness.

2. Description of the Related Art

Generally, a projection television is a rear surface projection type image displaying apparatus which displays an image by projecting the image on a rear surface of a screen so that a user positioned at a front side of the television is able to see the image. Referring to FIG. 1, a conventional projection television includes a cabinet 10 in which a screen 11 is installed, a projector 13 installed in the cabinet 10, and a reflecting mirror 12 for reflecting the image projected from the projector 13 on the rear surface of the screen 11. Therefore, the image projected from the projector 13 is reflected by the reflecting mirror 12 and formed on the rear surface of the screen 11.

However, an image projection path formed from the projector 13 to the screen 11 as passing through the reflecting mirror 12 requires a large amount of space of the cabinet 10, thus increasing a thickness (X) of the cabinet 10. When the thickness (X) of the cabinet 10 becomes thicker and thicker, a large installation space of the cabinet 10 is required. Furthermore, it is difficult to move the projection television due to a large volume of the television.

Therefore, a projection television having new structure by which the above and/or other problems can be solved is required.

### SUMMARY OF THE INVENTION

It is an aspect of the present general inventive concept to provide a projection television having a variable thickness which can be reduced when the television is not used.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a projection television that may include a front case on which a screen is installed; a rear case forming a cabinet main body with the front case; a projector installed in the main body; a reflecting mirror installed in the main body for reflecting an image projected from the projector onto the screen; a coupling device for coupling the front case and the rear case so that the front case can reach and separate from the rear case, wherein the main body has a variable thickness.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view of a structure in a conventional projection television;

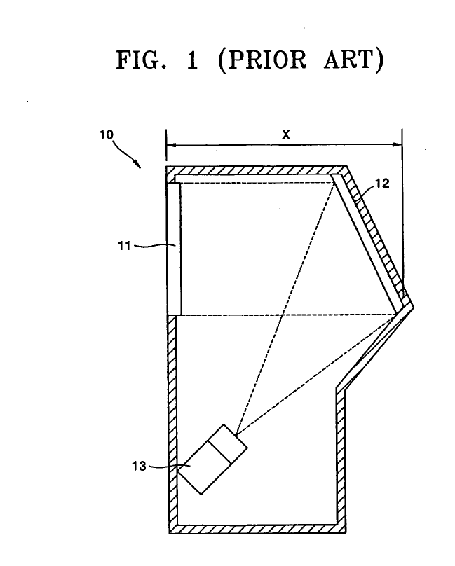

FIG. 2 is a schematic cross-sectional view of a projection television according to an embodiment of the present general inventive concept;

FIG. 3 is a schematic cross-sectional view of the projection television of FIG. 2 in a storing away state;

FIG. 4 is a schematic cross-sectional view of a front cabinet side in the projection television of FIG. 2;

FIG. 5 is a schematic cross-sectional view of a rear cabinet side in the projection television of FIG. 2; and

FIG. 6 is a view showing processes of converting the television from the state of FIG. 3 to the state of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

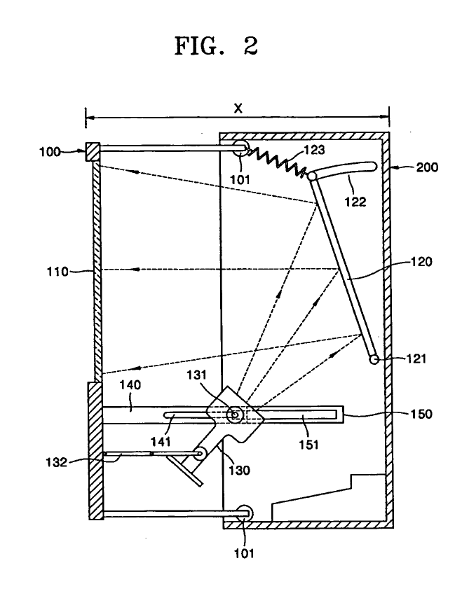

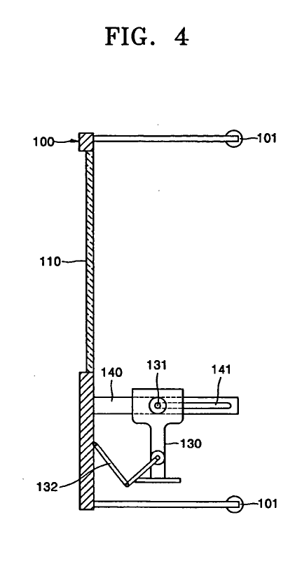

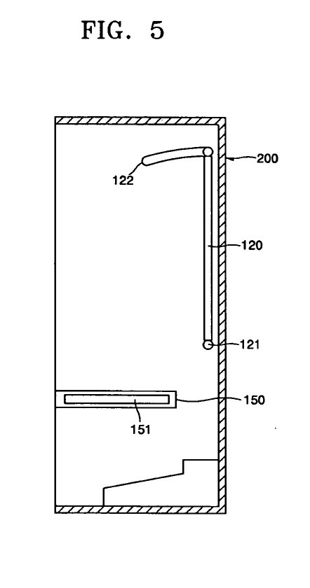

Referring to FIGS. 2 through 6, a front case 100 and a rear case 200 forming a main body of a projection television are coupled so as to approach each other or separate from each other by a coupling device.

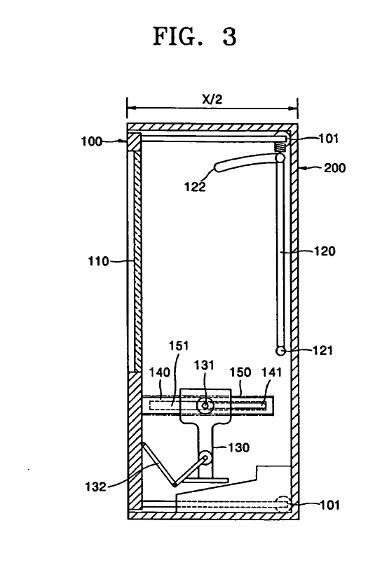

That is, as shown in FIG. 3, the front case 100 can be moved so that a front panel thereof on which a screen 110 is installed is exposed, and other portions of the projection television enter the rear case 200, or as shown in FIG. 2, the front case 100 can be moved out of the rear case 200. Reference numeral 101 denotes a moving roller.

Also, the main body includes a projector 130 for projecting an image, and a reflecting mirror 120 to reflect the projected image onto the screen 110.

The coupling device includes a projecting angle controlling unit that can control a projected angle of the image from the projector 130, and a reflecting angle controlling unit that can control an installation angle of the reflecting mirror 120.

The projecting angle controlling unit can include a pivotal shaft supporting member that can support a first pivotal shaft 131, and a link member 132 that can connect the front case 100 to one end portion of the projector 130. The pivotal shaft supporting member can include a fixing bar 140 which can be disposed on the front case so as to support the first pivotal shaft 131 disposed on the other end portion of the projector 130, and a first guide rail 150 which can be disposed on the rear case 200 so as to support the first pivotal shaft 131 to be slid. First and second guide recesses 141 and 151, respectively, are disposed respectively on the fixing bar 140 and the first guide rail 150 to guide the first pivotal shaft 131 to be slid.

Therefore, when the front case 100 moves, the end portion of the projector 130 connected to the link member 132 can pivot while centering around the first pivotal shaft 131, and the projecting angle of the image is changed.

Also, the reflecting angle controlling unit can include a second pivotal shaft 121 disposed on one end portion of the reflecting mirror 120 and supported by the rear case 200, a second guide rail 122 supporting the other end portion of the reflecting mirror 120 along a pivot track of the reflecting mirror 120, and a connecting member 123 that can connect the front case 100 and the other end portion of the reflecting mirror 120. In an aspect of the general inventive concept the connecting member 123 can be made of a spring so as to soften vibrations transmitted to the reflecting mirror 120 when the reflecting mirror 120 pivots.

Therefore, when the front case 100 moves, the other end portion of the reflecting mirror 120 connected to the case 100 with the connecting member 123 pivots while centering around the second pivotal shaft 121, and the reflecting angle is changed.

In above construction, when the projection television is not used, the front case 100 can be pushed into the rear case 200 as shown in FIG. 3. Then the entire thickness of the projection television is reduced to half of the thickness X (X/2) when the television is not being used. Therefore, it can be easier to load or to carry the projection television, and even if the projection television is installed at a location to be used, the reduced installation space can be used for another use when the projection television is not presently being used. On the other hand, when the front case 100 is in the rear case 200, the projector 130 and the reflecting mirror 120 can stand in vertical directions, and the image is not output onto the screen 110 when the power source is turned on.

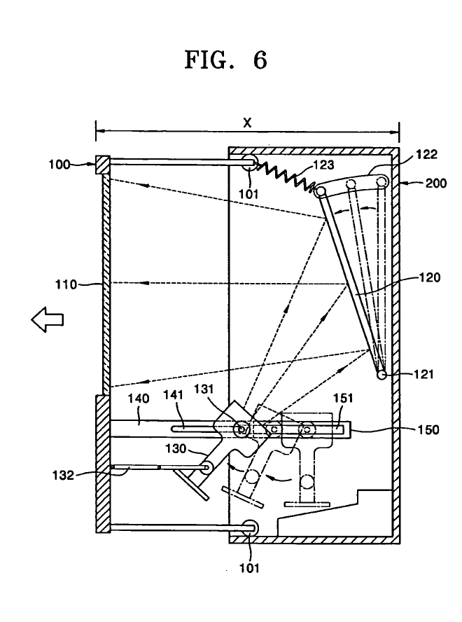

In contrast, when a user wants to watch the projection television, the front case 100 should be pulled out of the rear case 200 as shown in FIG. 6. Then, the other end portion of the reflecting mirror 120 is pulled by the connecting member 123, thus pivoting the reflecting mirror 120 to reflect the incident image onto the screen 110. Therefore, in the normal usage mode, the image projected from the projector 130 is reflected by the reflecting mirror 120 and formed on the screen 110.

As described above, the projection television can have a general thickness X in order to ensure the projection and reflection paths of the image when it is being used, and the thickness can be reduced to half of the general thickness X (X/2) when the projection television is not being used, thus carrying, wraping or storing the television conveniently and efficiently.

Further, the thickness of the projection television can be reduced when the projection television is not being used after installing the projection television at a usable location, and the reduced space can be used for another use efficiently.

In addition, the projection television can be installed in a built-in type space, and the installation space can be reduced even more.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A projection television comprising:
a front case on which a screen is installed;
a rear case forming a main body with the front case;
a projector installed in the main body;
a reflecting mirror installed in the main body to reflect an image projected from the projector onto the screen; and
a coupling device to couple the front case and the rear case so that the front case can reach and separate from the rear case,
wherein the main body has a variable thickness.

2. The projection television of claim 1, wherein the coupling device comprises:
a projecting angle controlling unit to change a projecting angle of the image projected from the projector by moving the projector together with the approach and separation of the front case and the rear case; and
a reflecting angle controlling unit to change a reflecting angle of the reflecting mirror by moving the reflecting mirror together with the approach and separation of the front case and the rear case.

3. The projection television of claim 2, wherein the projecting angle controlling unit comprises:
a pivotal shaft supporting member to support a first pivotal shaft disposed on one end portion of the projector to be pivotable; and
a link member to connect the front case and the other end portion of the projector,
wherein the other end portion of the projector connected by the link member pivots while centering around the first pivotal shaft according to the movement of the front case to change the projecting angle.

4. The projection television of claim 3, wherein the pivotal shaft supporting member comprises:
a fixing bar disposed on the front case to support the first pivotal shaft to be pivotable and slid; and
a first guide rail disposed on the rear case to support the first pivotal shaft to be pivotable and slid.

5. The projection television of claim 2, wherein the reflecting angle controlling unit comprises:
a second pivotal shaft disposed on a first end portion of the reflecting mirror and supported by the rear case;
a second guide rail supporting a second end portion of the reflecting mirror along a pivot track of the reflecting mirror; and
a connecting member to connect the front case and the second end portion of the reflecting mirror,
wherein the second end portion of the reflecting mirror connected to the front case by the connecting member pivots while centering around the second pivotal shaft according to the movement of the front case to change the reflecting angle.

6. The projection television of claim 5, wherein the connecting member is a spring.

7. A projection television comprising:
a main body including a rear case;
a projector pivotally installed in the rear case;
a front case on which a screen is provided, the front case being movable with respect to the rear case; and
a reflecting mirror pivotally installed in the rear case to reflect an image projected from the projector onto the screen.

8. The projection television of claim 7, wherein the rear case further comprises a projecting angle controlling unit that controls a projected angle of the image from the projector.

9. The projection television of claim 8, wherein the projecting angle controlling unit comprises:
a first pivotal shaft connected to a front portion of the projector to pivot the projector;
and a link member to connect the front case to another end of the projector such that the projector pivots when the front case is moved with respect to the rear case.

10. The projection television of claim 9, further comprising:
a fixing bar having a first guide recess and disposed on the front case to support the first pivotal shaft to be slid along the first guide recess; and
a first guide rail having a second guide recess in association with the first guide recess and disposed on the rear case to support the first pivotal shaft to be slid along the second guide recess.

11. The projection television of claim 10, wherein the reflecting angle controlling unit comprises:
a second pivotal shaft provided at a first end of the reflecting mirror to pivotally support the reflecting mirror;
a second guide rail to support a second end of the reflecting mirror along a pivot track of the reflecting mirror; and
a connecting member to connect the front case and the second end of the reflecting mirror such that the reflecting mirror is pivoted when the front case moves with respect to the rear case.

12. The projection television of claim 10, wherein the connecting member is flexible to resist vibrations when the reflection mirror pivots.

13. The projection television of claim 7, further comprising a roller connected at an upper portion and a lower portion of the front case to provide a rolling motion of the front case when the front case is moved with respect to the rear case.

14. A projection television comprising:
a rear case;
a front case on which a screen is installed, the front case being in a movable connection with the rear case such that the front case can extend towards and separate from the rear case to vary a thickness of the projection television;
a projector installed in one of the front case and the rear case; and
a reflecting mirror installed in one of the front case and the rear case to reflect an image projected from the projector onto the screen.

15. The projection television of claim 14, wherein the projector and the reflecting mirror pivot from a storage position to a projection position when the front case separates from the rear case to increase the thickness of the projection television.

16. A method of varying a thickness of a projection television having a screen and a projector therein, comprising:
moving a front case of the projection television with respect to a rear case such that the front case expands out of and contracts into the rear case.

17. The method of claim 16, wherein the operation of moving the front case further comprises controlling a projection angle of the projector to provide an image on the screen when the front case is in the expanded position.

18. The method of claim 17, wherein the operation of controlling a projection angle of the projector comprises pivoting the projector.

19. The method of claim 17, wherein the operation of moving the front case further comprises changing a reflecting angle of a reflecting mirror that reflects the projected image from the projector onto the screen by moving the reflecting mirror together with the moving of the front case.

20. The method of claim 19, wherein the operation of changing a reflecting angle of a reflecting mirror comprises pivoting the reflection mirror.
